(19) United States
(12) Patent Application Publication
(10) Pub. No.: US 2024/0152777 A1
(43) Pub. Date: May 9, 2024

(54) APPARATUS FOR TRAINING A PATH PREDICTION MODEL AND A METHOD THEREFOR

(71) Applicants: HYUNDAI MOTOR COMPANY, Seoul (KR); KIA CORPORATION, Seoul (KR)

(72) Inventors: Seulgi Kim, Suwon-si (KR); Yimju Kang, Seoul (KR)

(73) Assignees: HYUNDAI MOTOR COMPANY, Seoul (KR); KIA CORPORATION, Seoul (KR)

(21) Appl. No.: 18/136,687

(22) Filed: Apr. 19, 2023

(30) Foreign Application Priority Data
Nov. 3, 2022 (KR) 10-2022-0145335

(51) Int. Cl. G06N 5/022

(52) U.S. Cl. CPC G06N 5/022

(57) ABSTRACT

An apparatus for training a driving path prediction model of a vehicle and a method therefor are disclosed. The apparatus includes a sensor that obtains a time series of training images in a real environment and a controller that trains a path prediction model based on dynamic objects in the time series of training images. The controller is configured to train the path prediction model to recognize a dynamic object disappearing from the time series of training images and a dynamic object appearing in the time series of training images.

### CROSS-REFERENCE TO RELATED APPLICATION

This application claims the benefit of and priority to Korean Patent Application No. 10-2022-0145335, filed on Nov. 3, 2022 in the Korean Intellectual Property Office, the entire contents of which are incorporated herein by reference.

### TECHNICAL FIELD

The present disclosure relates to technologies of training a model for predicting a path of a dynamic object.

### BACKGROUND

In the field of artificial intelligence, an artificial neural network (ANN) is an algorithm that allows a machine to simulate and learn the human neural structure. Recently, ANNs have been applied to image recognition, speed recognition, natural language processing, and the like, and have shown excellent results. The ANN is composed of an input layer for receiving an input, a hidden layer for performing learning, and an output layer for returning a result of calculation. A plurality of hidden layers is referred to as a deep neural network (DNN). The DNN is a type of ANN.

The ANN allows a computer to learn on its own based on data. When solving a certain problem using the ANN, what needs to be prepared is an appropriate ANN model and data to be analyzed. An ANN model for solving a problem is learned based on data. Prior to learning the model, the data needs to be suitably processed. Standardized input and output data often lead to high accuracy of ANN models. Thus, obtained raw data needs to be processed to be suitable for use as the required input data. As the preprocessing of the data is completed, the processed data needs to be divided into two types. In particular, the processed data should be divided into a training dataset and a validation dataset. The training dataset is used to train the model, and the validation dataset is used to validate performance of the model.

There are several reasons for validating an ANN model. An ANN developer may correct a hyper parameter of the model based on the result of validating the model to tune the model. Furthermore, the model may be validated to select which model is suitable among several models. In more detail, several reasons for why model validation is necessary are as follows.

First, it is to predict accuracy. The purpose of the ANN is to achieve good performance on out-of-sample data which is not used for training. Therefore, after creating the model, it is essential to verify how well the model will perform on out-of-sample data. Because the model should not be validated using the training dataset, accuracy of the model should be measured using the validation dataset independent of the training dataset.

Secondly, it is to enhance performance of the model by tuning it. For example, overfitting may be prevented. Overfitting occurs when the model is overtrained on the training dataset. As an example, when training accuracy is high and when validation accuracy is low, the possibility of overfitting may be suspected. This may be identified in detail by means of a training loss and a validation loss. When overfitting occurs, it should be prevented to enhance accuracy of validation. Overfitting may be prevented using a method such as regularization and dropout.

Generally, because an existing technology for training a model for predicting a driving path of a vehicle trains the prediction model based on a time series of training images in which the number of vehicles is fixed, without regard to a real road environment in which a vehicle disappears from the field of view of a camera sensor or a new vehicle appears in the field of view of the camera sensor, the driving path of the vehicle is not predicted with high accuracy in the real road environment.

For example, when a training image at time point T includes a first vehicle, a second vehicle, and a third vehicle, and a training image at time point T+2 includes the first vehicle, the second vehicle, and the third vehicle, the existing technology trains the prediction model to predict feature information of the first vehicle, feature information of the second vehicle, and feature information of the third vehicle at the time point T+2 based on feature information of the first vehicle, feature information of the second vehicle, and feature information of the third vehicle at the time point T.

On the other hand, when one of the first vehicle, the second vehicle, or the third vehicle disappears from the training image at time point T+2 (or deviates from the field of view of the camera sensor) or when a new vehicle appears in the training image at time point T+2, the existing technology does not use the training image at time point T and the training image at time point T+2 to train the prediction model.

The foregoing is intended to merely aid in understanding the background of the present disclosure, and is not intended to mean that the present disclosure falls within the purview of an existing technology well known to those having ordinary skill in the art.

### SUMMARY

The present disclosure has been made to solve the above-mentioned problems occurring in the prior art while advantages achieved by the prior art are maintained intact.

An aspect of the present disclosure provides an apparatus for training a path prediction model to obtain a time series of training images in a real environment and train a prediction model based on the time series of training images to recognize a dynamic object disappearing from the time series of training images and a dynamic object newly appearing in the time series of training images to allow the prediction model to predict a path of the dynamic object to have high accuracy in the real environment and a method therefor.

The purposes of the present disclosure are not limited to the aforementioned purposes. Any other purposes and advantages not mentioned herein may be clearly understood from the following description. Furthermore, it should be understood that purposes and advantages of the present disclosure may be implemented by means indicated in the claims and a combination thereof.

According to an aspect of the present disclosure, an apparatus for path prediction model training may include a sensor that obtains a time series of training images in a real environment and a controller that trains a path prediction model based on dynamic objects in the time series of training images. The controller may train the path prediction model to recognize a dynamic object disappearing from the time series of training images and a dynamic object newly appearing in the time series of training images.

In an aspect, the controller may be configured to establish a training strategy for each of the dynamic objects in the time series of training images based on a training image at a current time point and a training image at a future time point. In an aspect, the controller may be configured to train

a first dynamic object in the training image at the current time point as a dynamic object disappearing from the training image at the future time point when the first dynamic object in the training image at the current time point disappears from the training image at the future time point.

In an aspect, the controller may be configured to determine a value indicating that the first dynamic object is the dynamic object disappearing at the future time point and trains the path prediction model using the value.

In an aspect, the controller may be configured to train a second dynamic object that is not present in a training image at a past time point as a dynamic object newly appearing in the training image at the current time point when the second dynamic object newly appears in the training image at the current time point.

In an aspect, the controller may be configured to determine a value indicating that the second dynamic object is the dynamic object newly appearing at the current time point and trains the path prediction model using the value.

In an aspect, the path prediction model may be a transformer network.

In an aspect, the transformer network may be configured to train a location of each of the dynamic objects at a future time point based on an input vector of each of the dynamic objects at a past time point and an input vector of each of the dynamic objects at a current time point.

In an aspect, the dynamic objects in the time series of training images may be vehicles, and the controller may be configured to extract feature information about each of the vehicles in the time series of training images as an input vector for the path prediction model.

In an aspect, the feature information about each of the vehicles may include at least one of a location, a speed, a heading angle, a heading angle rate, or a driving lane of each of the vehicles, or any combination thereof.

According to another aspect of the present disclosure, a method for path prediction model training may include obtaining, by a sensor, a time series of training images in a real environment and training, by a controller, a path prediction model based on the time series of training images. Training the path prediction model may include training the path prediction model to recognize a dynamic object disappearing from the time series of training images and a dynamic object newly appearing in the time series of training images.

In an aspect, training the path prediction model may include establishing a training strategy for each of the dynamic objects in the time series of training images based on a training image at a current time point and a training image at a future time point.

In an aspect, establishing the training strategy for each of the dynamic objects may include training a first dynamic object in the training image at the current time point as a dynamic object disappearing from the training image at the future time point when the first dynamic object in the training image at the current time point disappears from the training image at the future time point.

In an aspect, training the first dynamic object in the training image at the current time point as the dynamic object disappearing from the training image at the future time point may include determining a value indicating that the first dynamic object is the dynamic object disappearing at the future time point and training the path prediction model using the determined value.

In an aspect, establishing the training strategy for each of the dynamic objects may include training a second dynamic object which is not present in a training image at a past time point as a dynamic object newly appearing in the training image at the current time point when the second dynamic object newly appears in the training image at the current time point.

In an aspect, training the second dynamic object as the dynamic object newly appearing in the training image at the current time point may include determining a value indicating that the second dynamic object is the dynamic object newly appearing at the current time point and training the path prediction model using the determined value.

In an aspect, the path prediction model may be a transformer network.

In an aspect, the transformer network may train a location of each of the dynamic objects at a future time point based on an input vector of each of the dynamic objects at a past time point and an input vector of each of the dynamic objects at a current time point.

In an aspect, the dynamic objects in the time series of training images may be vehicles, and training of the path prediction model of the dynamic object may include extracting feature information about each of the vehicles in the time series of training images as an input vector for the path prediction model.

In an aspect, the feature information about each of the vehicles may include at least one of a location, a speed, a heading angle, a heading angle rate, or a driving lane of each of the vehicles, or any combination thereof.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of an apparatus for training a path prediction model according to an embodiment of the present disclosure;

FIG. 2 is a drawing illustrating a training image at a time point when T=1 that is obtained from a camera sensor by a controller provided in an apparatus for training a path prediction model according to an embodiment of the present disclosure;

FIG. 3 is a drawing illustrating a training image at a time point when T=2 that is obtained from a camera sensor by a controller provided in an apparatus for training a path prediction model according to an embodiment of the present disclosure;

FIG. 4 is a drawing illustrating a training image at a time point when T=3 that is obtained from a camera sensor by a controller provided in an apparatus for training a path prediction model according to an embodiment of the present disclosure;

FIG. 5 is a drawing illustrating a training image at a time point when T=4 that is obtained from a camera sensor by a controller provided in an apparatus for training a path prediction model according to an embodiment of the present disclosure;

FIG. 6 is a drawing illustrating a training image at a time point when T=5 that is obtained from a camera sensor by a controller provided in an apparatus for training a path prediction model according to an embodiment of the present disclosure;

FIG. 7 is a drawing illustrating a training image at a time point when T=6 that is obtained from a camera sensor by a controller provided in an apparatus for training a path prediction model according to an embodiment of the present disclosure;

FIG. 8 is a drawing illustrating a training image at a time point when T=7 that is obtained from a camera sensor by a controller provided in an apparatus for training a path prediction model according to an embodiment of the present disclosure;

FIG. 9 is a diagram illustrating performance of a path prediction model according to an embodiment of the present disclosure;

FIG. 10 is a flowchart illustrating a method for training a path prediction model according to an embodiment of the present disclosure; and

FIG. 11 is a block diagram illustrating a computing system for executing a method for training a path prediction model according to an embodiment of the present disclosure.

### DETAILED DESCRIPTION

Hereinafter, embodiments of the present disclosure are described in detail with reference to the accompanying drawings. In the accompanying drawings, identical or equivalent components are designated by identical numerals even when they are displayed in different drawings. Further, in describing the embodiments of the present disclosure, where it has been considered that a specific description of well-known features or functions may obscure the gist of the present disclosure, a detailed description thereof has been omitted.

In describing the components of the embodiment according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms, including technical and scientific terms, used herein should be interpreted as is customary in the art to which the present disclosure pertains. Such terms as those defined in a generally used dictionary should be interpreted as having meanings consistent with the contextual meanings in the relevant field of art, and should not be interpreted as having ideal or excessively formal meanings unless clearly defined as having such in the present disclosure.

When a component, device, element, or the like of the present disclosure is described as having a purpose or performing an operation, function, or the like, the component, device, or element should be considered herein as being “configured to” meet that purpose or perform that operation or function.

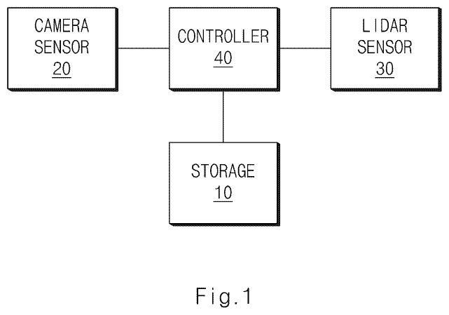

FIG. 1 is a block diagram illustrating an example configuration of an apparatus for training a path prediction model, according to an embodiment of the present disclosure.

As shown in FIG. 1, the apparatus for training the path prediction model according to an embodiment of the present disclosure may include storage 10, a camera sensor 20, a light detection and ranging (LiDAR) sensor 30, and a controller 40. In some examples, the respective components may be combined into one component and some components may be omitted, depending on a manner in which the apparatus for training the path prediction model according to an embodiment of the present disclosure is implemented.

The storage 10 may store various logic, algorithms, and programs for obtaining a time series of training images in a real environment (e.g., a real road environment) and training a prediction model based on the time series of training images to recognize a dynamic object (e.g., a vehicle, a person, or an animal) disappearing from the time series of training images and a dynamic object newly appearing in the time series of training images.

Such storage 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The camera sensor 20 may obtain a time series of training images in a real environment (e.g., a real road environment). Although the sensor used for obtaining the time series of training images is generally described herein as being the camera sensor 20 as an example, a radar sensor (not shown) as well as the LiDAR sensor 30 may additionally or alternatively be used as the sensor for obtaining the time series of training images in some embodiments.

The camera sensor 20 may have a certain field of view and may recognize motion of an object (e.g., a vehicle, a person, an animal, or the like) within a range of the field of view. For example, an angle of view of a lens of the camera sensor 20 may vary. A narrow-angle camera may cover a range of 40 degrees to 60 degrees. A wide-angle camera may cover a range of 60 degrees to 80 degrees. A fisheye lens may cover up to 180 degrees. However, because the focal length varies with the angle of view, an object input and output from an actual field of view may change according to the angle of view.

The LiDAR sensor 30 may generate a point cloud for a vehicle and a traffic line located on the road.

The controller 40 may perform the overall control such that respective components may perform their own functions. Such a controller 40 may be implemented in the form of hardware, may be implemented in the form of software, or may be implemented in the form of a combination thereof. The controller 40 may be implemented as, but not limited to, a microprocessor.

The controller 40 may perform a variety of control operations for obtaining a time series of training images in a real environment and training a prediction model to recognize a dynamic object disappearing from the time series of training images and a dynamic object newly appearing in the time series of training images.

The controller 40 may extract feature information about each dynamic object (e.g., a vehicle) in the time series of training images as an input vector for the prediction model (e.g., a transformer network). In the process of extracting the input vector, the controller 40 may receive an image (e.g., a road image) from the camera sensor 20 and may perform semantic segmentation of the image based on convolutional neural networks (CNN). The controller 40 may also receive a point cloud corresponding to the image from the LiDAR sensor 30 and may match the image, of which the semantic segmentation has been performed, with the point cloud. The controller 40 may detect a vehicle and a traffic line from the image received from the camera sensor 20 and may track the vehicle and the traffic line. In an example, the controller 40 may track the vehicle and the traffic line using an unscented Kalman filter-based constant Turn rate and velocity (CTRV) model. The feature information of the vehicle may include a location (x, y) of the vehicle, a speed of the vehicle, a heading angle of the vehicle, a heading angle rate of the vehicle, and a driving lane of the vehicle. The heading angle rate refers to a heading angular speed of the vehicle.

Furthermore, the controller 40 may train the prediction model to predict a location of each vehicle at a future time point (T+2 seconds) based on an input vector of each vehicle at a current time point T. The controller 40 may then connect locations of the vehicle at future time points to generate a driving route of the vehicle.

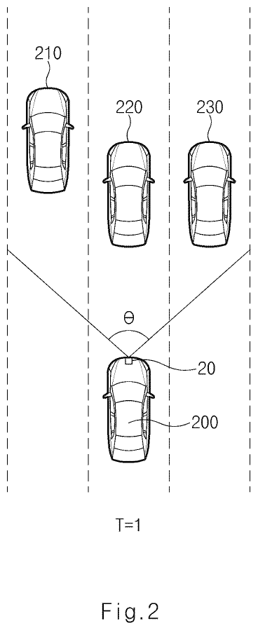

Hereinafter, a process performed by the controller 40 to train the path prediction model to recognize (or train) a vehicle 220 disappearing from a time series of training images and vehicles 240 and 250 newly appearing in the time series of training images is described in detail with reference to FIGS. 2-6.

FIG. 2 is a drawing illustrating a training image at a time point when T=1 that is obtained from a camera sensor by a controller provided in an apparatus for training a path prediction model according to an embodiment of the present disclosure.

FIG. 2 depicts an ego vehicle 200 having a camera sensor 20 with a predetermined angle of view θ, a first vehicle 210 at the time point when T=1 (Car1_1), a second vehicle 220 at the time point when T=1 (Car2_1), and a third vehicle 230 at the time point when T=1 (Car3_1).

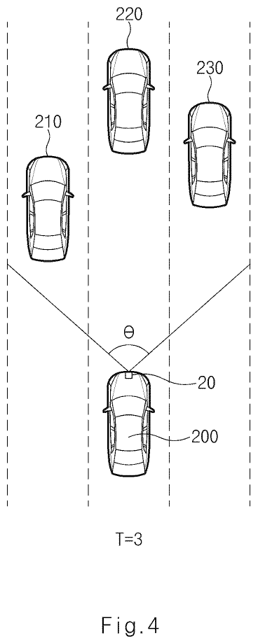

As the first vehicle 210, the second vehicle 220, and the third vehicle 230 are located within the angle of view of the camera sensor 20 as shown in FIG. 2 and the first vehicle 210, the second vehicle 220, and the third vehicle 230 are located within the angle of view of the camera sensor 20 as shown in FIG. 4, the controller 40 of FIG. 1 may establish a training strategy depicted in Table 1 below.

TABLE 1

| T | Input | | | | | T + 2 | Output | | | | |
|---|---|---|---|---|---|---|---|---|---|---|---|
| 1 | Car1_1 | Car2_1 | Car3_1 | <init> | . | 3 | Car1_3 | Car2_3 | Car3_3 | <init> | . |
| | | | | | . | | | | | | . |
| | | | | | . | | | | | | . |

As shown in Table 1, the controller 40 may train a prediction model to predict a location of the first vehicle 210 at a time point when T=3 (Car1_3) based on an input vector of the first vehicle 210 at the time point when T=1 (Car1_1). The controller 40 may train the prediction model to predict a location of the second vehicle 220 at the time point when T=3 (Car2_3) based on an input vector of the second vehicle at the time point when T=1 (Car2_1). The controller 40 may also train the prediction model to predict a location of the third vehicle 230 at the time point when T=3 (Car3_3) based on an input vector of the third vehicle 230 at the time point when T=1 (Car3_1). Herein, <init> may indicate an empty field the loss of which is not updated during training, and the value of <init> may be determined according to an intention of a designer.

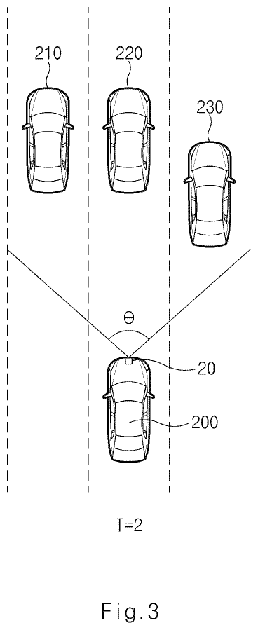

FIG. 3 is a drawing illustrating a training image at a time point when T=2 that is obtained from a camera sensor by a controller provided in an apparatus for training a path prediction model according to an embodiment of the present disclosure.

FIG. 3 depicts the ego vehicle 200 having the camera sensor 20 with the predetermined angle of view θ, the first vehicle 210 at the time point when T=2 (Car1__2), the second vehicle 220 at the time point when T=2 (Car2_2), and the third vehicle 230 at the time point when T=2 (Car3_2).

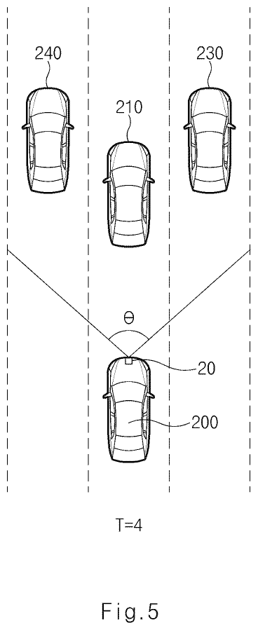

As the first vehicle 210, the second vehicle 220, and the third vehicle 230 are located within the angle of view of the camera sensor 20 as shown in FIG. 3, but the second vehicle 220 disappears from the angle of view of the camera sensor 20 as shown in FIG. 5, the controller 40 of FIG. 1 may establish a training strategy such as depicted in Table 2 below. At this time, as a fourth vehicle 240 newly appearing in an image at a future time point when T=4 is not a training target at a current time when T=2, it is ignored.

TABLE 2

| T | Input | | | | | T + 2 | Output | | | | |
|---|---|---|---|---|---|---|---|---|---|---|---|
| 2 | Car1_2 | Car2_2 | Car3_2 | <init> | . | 4 | Car1_4 | <Out> | Car3_4 | <init> | . |
| | | | | | . | | | | | | . |
| | | | | | . | | | | | | . |

As shown in Table 2, as the second vehicle 220 disappears from the angle of view of the camera sensor 20 as shown in FIG. 5, the controller 40 may assign <Out> token to a field of the second vehicle 220 at the time point when T=4 (Car2_4).

The controller 40 may train a prediction model to predict a location of the first vehicle 210 at the time point when T=4 (Car1_4) based on an input vector of the first vehicle 210 at the time point when T=2 (Car1__2). The controller 40 may train the prediction model to predict that the second vehicle 220 at the time point when T=2 (Car2_2) is a vehicle to deviate from the angle of view of the camera sensor 20 at the time point when T=4. The controller 40 may also train the prediction model to predict a location of the third vehicle 230 at the time point when T=4 (Car3_4) based on an input vector of the third vehicle 230 at the time point when T=2 (Car3_2).

FIG. 4 is a drawing illustrating a training image at a time point when T=3 that is obtained from a camera sensor by a controller provided in an apparatus for training a path prediction model according to an embodiment of the present disclosure.

FIG. 4 depicts the ego vehicle 200 having the camera sensor 20 with the predetermined angle of view θ, the first vehicle 210 at the time point when T=3 (Car1_3), the second vehicle 220 at the time point when T=3 (Car2_3), and the third vehicle 230 at the time point when T=3 (Car3_3).

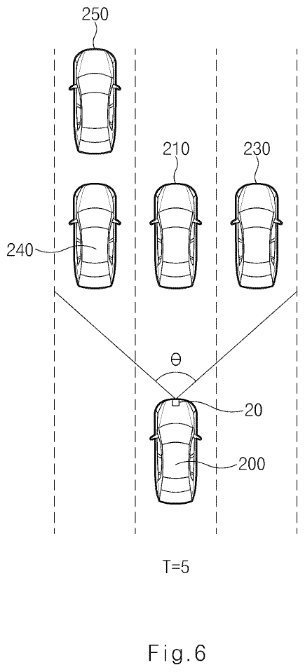

As the first vehicle 210, the second vehicle 220, and the third vehicle 230 are located within the angle of view of the camera sensor 20 as shown in FIG. 4, but the second vehicle 220 disappears from the angle of view of the camera sensor 20 as shown in FIG. 6, the controller 40 of FIG. 1 may establish a training strategy such as depicted in Table 3. At this time, as the fourth vehicle 240 and a fifth vehicle 250, which newly appear in an image at a future time point when T=5, are not training targets at a current time when T=3, they are ignored.

TABLE 3

| T | Input | | | | | T + 2 | Output | | | | |
|---|---|---|---|---|---|---|---|---|---|---|---|
| 3 | Car1_3 | Car2_3 | Car3_2 | <init> | . | 5 | Car1_5 | <Out> | Car3_5 | <init> | . |
| | | | | | . | | | | | | . |
| | | | | | . | | | | | | . |

As shown in Table 3, as the second vehicle 220 disappears from the angle of view of the camera sensor 20 as shown in FIG. 6, the controller 40 may assign <Out> token to a field of the second vehicle 220 at the time point when T=5 (Car2_5).

The controller 40 may train a prediction model to predict a location of the first vehicle 210 at the time point when T=5 (Car1_5) based on an input vector of the first vehicle 210 at the time point when T=3 (Car1_3). The controller 40 may train the prediction model to predict that the second vehicle 220 at the time point when T=3 (Car2_3) is a vehicle to deviate from the angle of view of the camera sensor 20 at the time point when T=5. The controller 40 may also train the prediction model to predict a location of the third vehicle 230 at the time point when T=5 (Car3_5) based on an input vector of the third vehicle 230 at the time point when T=3 (Car3_3).

FIG. 5 is a drawing illustrating a training image at a time point when T=4 that is obtained from a camera sensor by a controller provided in an apparatus for training a path prediction model according to an embodiment of the present disclosure.

FIG. 5 depicts the ego vehicle 200 having the camera sensor 20 with the predetermined angle of view θ, a first vehicle 210 at the time point when T=4 (Car1_4), the third vehicle 230 at the time point when T=4 (Car3_4), and the fourth vehicle 240 at the time point when T=4 (Car4_4).

As the first vehicle 210, the third vehicle 230, and the fourth vehicle 240 are located within the angle of view of the camera sensor 20 as shown in FIG. 5, the controller 40 of FIG. 1 may recognize that the second vehicle 220 disappears from the angle of view of the camera sensor 20 and the fourth vehicle 240 newly appears in the angle of view of the camera sensor 20.

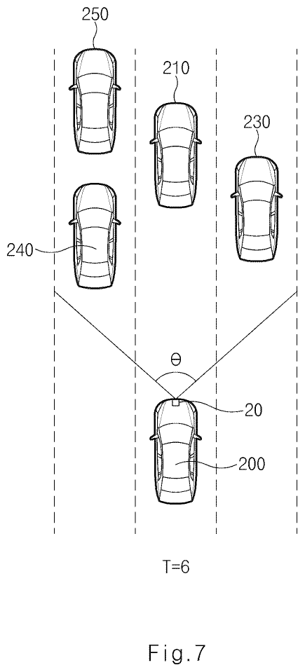

In addition, as the first vehicle 210, the third vehicle 230, and the fourth vehicle 240 are located within the angle of view of the camera sensor 20 as shown in FIG. 7, the controller 40 may establish a training strategy such as depicted in Table 4 below. At this time, as the fifth vehicle 250 newly appearing in an image at a future time point when T=6 is not a training target at a current time when T=4, it is ignored.

TABLE 4

| T | Input | | | | | T + 2 | Output | | | | |
|---|---|---|---|---|---|---|---|---|---|---|---|
| 4 | Car1_4 | <init> | Car3_4 | Car4_4 | . | 6 | Car1_6 | <init> | Car3_6 | Car4_6 | . |
| | | | | | . | | | | | | . |
| | | | | | . | | | | | | . |

As shown in Table 4, as the second vehicle 220 disappears from the angle of view of the camera sensor 20, the controller 40 assigns <init> token to a field corresponding to the second vehicle 220 (Car2_4) and adds the fourth vehicle Car4_4, which newly appears, to the table.

The controller 40 may train a prediction model to predict a location of the first vehicle 210 at the time point when T=6 (Car1_6) based on an input vector of the first vehicle 210 at the time point when T=4 (Car1_4). The controller 40 may train the prediction model to predict a location of the third vehicle 230 at the time point when T=6 (Car3_6) based on an input vector of the third vehicle 230 at the time point when T=4 (Car3_4). The controller 40 may also train the prediction model to predict a location of the fourth vehicle 240 at the time point when T=6 (Car4_6) based on an input vector of the fourth vehicle 240 at the time point when T=4 (Car4_4).

FIG. 6 is a drawing illustrating a training image at a time point when T=5 that is obtained from a camera sensor by a controller provided in an apparatus for training a path prediction model according to an embodiment of the present disclosure.

FIG. 6 depicts the ego vehicle 200 having the camera sensor 20 with the predetermined angle of view θ, the first vehicle 210 at the time point when T=5 (Car1_5), the third vehicle 230 at the time point when T=5 (Car3_5), the fourth vehicle 240 at the time point when T=5 (Car4_5), and the fifth vehicle 250 at the time point when T=5 (Car5_5).

As the first vehicle 210, the third vehicle 230, the fourth vehicle 240, and the fifth vehicle 250 are located within the angle of view of the camera sensor 20 as shown in FIG. 6, the controller 40 of FIG. 1 may recognize that the fifth vehicle 250 newly appears in the angle of view of the camera sensor 20.

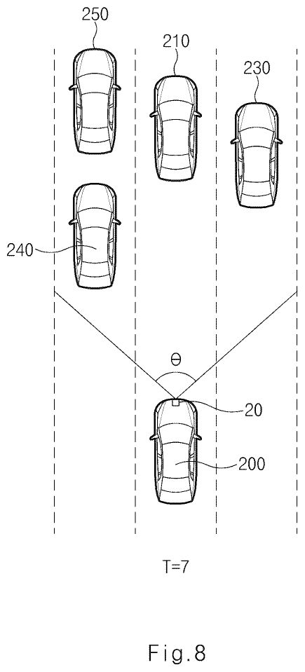

In addition, as the first vehicle 210, the third vehicle 230, the fourth vehicle 240, and the fifth vehicle 250 are located within the angle of view of the camera sensor 20 as shown in FIG. 8, the controller 40 may establish a training strategy such as depicted in Table 5 below.

TABLE 5

| T | Input | | | | | T + 2 | Output | | | | |
|---|---|---|---|---|---|---|---|---|---|---|---|
| 5 | Car1_5 | Car5_5 | Car3_5 | Car4_5 | . | 7 | Car1_7 | Car5_7 | Car3_7 | Car4_7 | . |
| | | | | | . | | | | | | . |
| | | | | | . | | | | | | . |

As shown in Table 5, the controller 40 may recognize that the fifth vehicle 250 newly appears in the angle of view of the camera sensor 20 and may add the fifth vehicle 250 (Car5_5) to the table.

The controller 40 may train a prediction model to predict a location of the first vehicle 210 at the time point when T=7 (Car1_7) based on an input vector of the first vehicle 210 at the time point when T=5 (Car1_5). The controller 40 may train the prediction model to predict a location of the third vehicle 230 at the time point when T=7 (Car3_7) based on an input vector of the third vehicle 230 at the time point when T=5 (Car3_5). The controller 40 may train the prediction model to predict a location of the fourth vehicle 240 at the time point when T=7 (Car4_7) based on an input vector of the fourth vehicle 240 at the time point when T=5 (Car4_5). The controller 40 may also train the prediction model to predict a location of the fifth vehicle 250 at the time point when T=7 (Car5_7) based on an input vector of the fifth vehicle 250 at the time point when T=5 (Car5_5).

FIG. 7 is a drawing illustrating a training image at a time point when T=6 that is obtained from a camera sensor by a controller provided in an apparatus for training a path prediction model according to an embodiment of the present disclosure.

FIG. 7 depicts the ego vehicle 200 having the camera sensor 20 with the predetermined angle of view θ, the first vehicle 210 at the time point when T=6 (Car1_6), the third vehicle 230 at the time point when T=6 (Car3_6), the fourth vehicle 240 at the time point when T=6 (Car4_6), and the fifth vehicle 250 at the time point when T=6 (Car5_6).

FIG. 8 is a drawing illustrating a training image at a time point where T=7 that is obtained from a camera sensor by a controller provided in an apparatus for training a path prediction model, according to an embodiment of the present disclosure.

FIG. 8 depicts the ego vehicle 200 having the camera sensor 20 with the predetermined angle of view θ, the first vehicle 210 at the time point when T=7 (Car1_7), the third vehicle 230 at the time point when T=7 (Car3_7), the fourth vehicle 240 at the time point when T=7 (Car4_7), and the fifth vehicle 250 at the time point when T=7 (Car5_7).

In various embodiments, the prediction model may determine a loss based on Equation 1 below. As seen in Equation 1, the prediction model does not reflect <init> token in loss (or training).

$$Loss = {L}_{< i n i t >} + {L}_{n o t < i n i t >} = \frac{{L}_{C a r ( Not Available in FOV )} \times 0}{{N}_{Masked Area}} + \frac{{L}_{C a r ( Available in FOV )}}{{N}_{UnMasked Area}} \qquad Equation 1$$

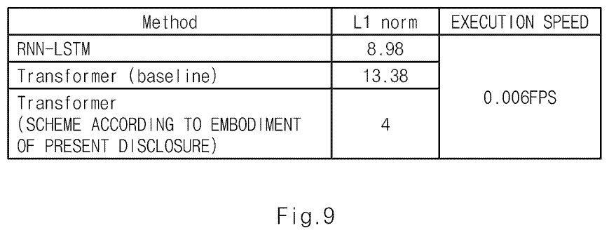

FIG. 9 is a drawing illustrating performance of a path prediction model according to an embodiment of the present disclosure.

In FIG. 9, “L1 norm” denotes the error calculation metric, and the execution speed is 0.006 frame per second (FPS).

As shown in FIG. 9, the error in RNN-LSTM-based driving path prediction model is 8.98, the error in transformer network (baseline) trained in an existing scheme is 13.38, and the error in transformer network trained in a scheme according to an embodiment of the present disclosure is 4.

It may thus be seen that the error in transformer network trained in the scheme according to an embodiment of the present disclosure decreases by 70% compared to the error in transformer network (baseline) trained in the existing scheme and decreases by 55.4% compared to the error in RNN-LSTM-based driving path prediction model.

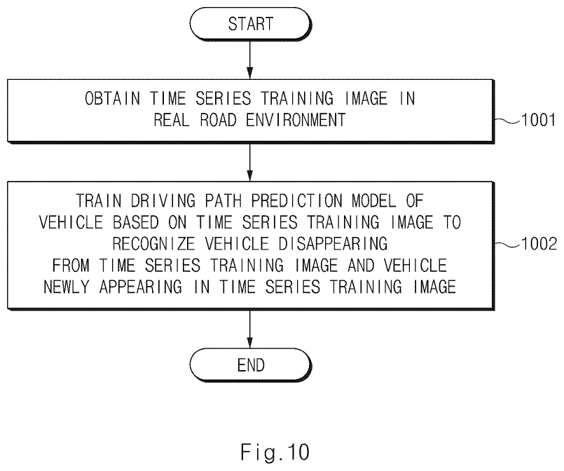

FIG. 10 is a flowchart illustrating a method for training a path prediction model according to an embodiment of the present disclosure.

In operation 1001, the camera sensor 20 of FIG. 1 may obtain a time series of training images in a real road environment.

In operation 1002, the controller 40 of FIG. 1 may train a driving path prediction model of a vehicle based on the time series of training images to recognize a vehicle disappearing from the time series of training images and a vehicle newly appearing in the time series of training images.

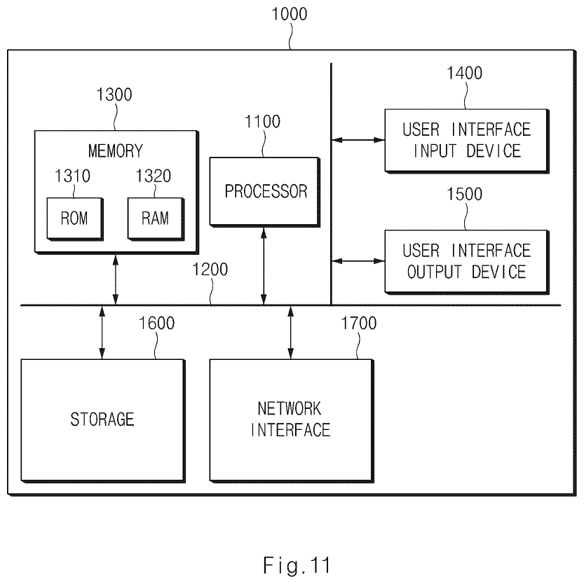

FIG. 11 is a block diagram illustrating a computing system for executing a method for training a driving path prediction model of a vehicle according to an embodiment of the present disclosure.

Referring to FIG. 11, the above-mentioned method for training the driving path prediction model of the vehicle according to an embodiment of the present disclosure may be implemented by means of a computing system 1000. The computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

In various embodiments, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a SSD (Solid State Drive), a removable disk, and a CD-ROM. The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus for training the driving path prediction model of the vehicle and the method therefor may be provided to obtain a time series of training images in a real environment and train the prediction model based on the time series of training images to recognize a dynamic object disappearing from the time series of training images and a dynamic object newly appearing in the time series of training images, thus allowing the prediction model to predict a path of the dynamic object to have high accuracy in the real environment.

Hereinabove, although the present disclosure has been described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

Therefore, embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for path prediction model training, the apparatus comprising:
a sensor configured to obtain a time series of training images in a real environment; and
a controller configured to train a path prediction model based on dynamic objects in the time series of training images,
wherein the controller is configured to train the path prediction model to recognize a dynamic object disappearing from the time series of training images and a dynamic object newly appearing in the time series of training images.

2. The apparatus of claim 1, wherein the controller is configured to establish a training strategy for each of the dynamic objects based on a training image at a current time point and a training image at a future time point.

3. The apparatus of claim 2, wherein the controller is configured to train a first dynamic object in the training image at the current time point as a dynamic object disappearing from the training image at the future time point when the first dynamic object in the training image at the current time point disappears from the training image at the future time point.

4. The apparatus of claim 3, wherein the controller is configured to determine a value indicating that the first dynamic object is the dynamic object disappearing at the future time point and train the path prediction model using the value.

5. The apparatus of claim 2, wherein the controller is configured to train a second dynamic object that is not present in a training image at a past time point as a dynamic object newly appearing in the training image at the current time point when the second dynamic object newly appears in the training image at the current time point.

6. The apparatus of claim 5, wherein the controller is configured to determine a value indicating that the second dynamic object is the dynamic object newly appearing at the current time point and train the path prediction model using the value.

7. The apparatus of claim 1, wherein the path prediction model is a transformer network.

8. The apparatus of claim 7, wherein the transformer network is configured to train a location of each of the dynamic objects at a future time point based on an input vector of each of the dynamic objects at a past time point and an input vector of each of the dynamic objects at a current time point.

9. The apparatus of claim 1, wherein:
the dynamic objects in the time series of training images are vehicles, and
the controller is configured to extract feature information about each of the vehicles in the time series of training images as an input vector for the path prediction model.

10. The apparatus of claim 9, wherein the feature information about each of the vehicles includes at least one of a location, a speed, a heading angle, a heading angle rate, or a driving lane of each of the vehicles, or any combination thereof.

11. A method for training a path prediction model, the method comprising:
obtaining, by a sensor, a time series of training images in a real environment; and
training, by a controller, a path prediction model based on dynamic objects in the time series of training images,
wherein training of the path prediction model includes:
training the path prediction model to recognize a dynamic object disappearing from the time series of training images and a dynamic object newly appearing in the time series of training images.

12. The method of claim 11, wherein the training of the path prediction model includes:
establishing, by the controller, a training strategy for each of the dynamic objects based on a training image at a current time point and a training image at a future time point.

13. The method of claim 12, wherein establishing the training strategy for each of the dynamic objects includes:
training, by the controller, a first dynamic object in the training image at the current time point as a dynamic object disappearing from the training image at the future time point when the first dynamic object in the training image at the current time point disappears from the training image at the future time point.

14. The method of claim 13, wherein training the first dynamic object in the training image at the current time point as the dynamic object disappearing from the training image at the future time point includes:
determining, by the controller, a value indicating that the first dynamic object is the dynamic object disappearing at the future time point, and
training, by the controller, the path prediction model using the determined value.

15. The method of claim 12, wherein establishing the training strategy for each of the dynamic objects includes:
training, by the controller, a second dynamic object that is not present in a training image at a past time point as a dynamic object newly appearing in the training image at the current time point when the second dynamic object newly appears in the training image at the current time point.

16. The method of claim 15, wherein training the second dynamic object as the dynamic object newly appearing in the training image at the current time point includes:
determining, by the controller, a value indicating that the second dynamic object is the dynamic object newly appearing at the current time point, and
training, by the controller, the path prediction model using the determined value.

17. The method of claim 11, wherein the path prediction model is a transformer network.

18. The method of claim 17, wherein the transformer network trains a location of each of the dynamic objects at a future time point based on an input vector of each of the dynamic objects at a past time point and an input vector of each of the dynamic objects at a current time point.

19. The method of claim 11, wherein:
the dynamic objects in the time series of training images are vehicles, and
training of the path prediction model includes extracting, by the controller, feature information about each of the vehicles in the time series of training images as an input vector for the path prediction model.

20. The method of claim 19, wherein the feature information about each of the vehicles includes at least one of a location, a speed, a heading angle, a heading angle rate, or a driving lane of each of the vehicles, or any combination thereof.
